(19) United States
(12) Patent Application Publication
(10) Pub. No.: US 2025/0105318 A1
(43) Pub. Date: Mar. 27, 2025

(54) HUMIDIFIER, METHOD FOR PRODUCING SUCH A HUMDIFIER AND FUEL CELL SYSTEM WITH SUCH A HUMIDIFIER

(71) Applicant: MAHLE International GmbH, Stuttgart (DE)

(72) Inventors: Stefan Moedinger, Remseck a.N. (DE); Samuel Kohler, Weil im Schoenbuch (DE); Alexander Jerger, Sachsenheim (DE); Tobias Baumgart, Winterbach (DE)

(21) Appl. No.: 18/896,870

(22) Filed: Sep. 25, 2024

(30) Foreign Application Priority Data
Sep. 26, 2023 (DE) 10 2023 209 406.1

(51) Int. Cl. H01M 8/04119

(52) U.S. Cl. CPC H01M 8/04149; H01M 8/04141

(57) ABSTRACT

A humidifier for humidifying dry cathode incoming air via humid cathode outgoing air for a fuel cell system may include a housing, two end plates, supporting elements, and a membrane stack including membranes arranged one after another in a stacking direction. The membrane stack may have two opposing first longitudinal faces, two opposing second longitudinal faces, and two opposing end faces. Fluid may be flowable through the first and second longitudinal faces and may not be flowable through the two end faces. The first and second longitudinal faces may be aligned parallel to the stacking direction. The two end faces may be aligned transversely to the stacking direction. The supporting elements may be configured to absorb forces acting along the stacking direction, arranged in pairs opposite each other on the first and/or second longitudinal faces, and/or attached to the two end plates.

### CROSS-REFERENCE TO RELATED APPLICATIONS

This application claims priority to German Patent Application No. 10 2023 209 406.1, filed on Sep. 26, 2023, the contents of which is hereby incorporated by reference in its entirety.

### TECHNICAL FIELD

The invention relates to a humidifier. The invention relates in particular to a method for manufacturing such a humidifier and, in particular, to a fuel cell system comprising at least one such humidifier.

### BACKGROUND

A humidifier of the type mentioned above is discussed in the document DE 10 2021 207 424 A1. It is designed to humidify dry cathode incoming air using humid cathode outgoing air in a fuel cell system and is characterized by a housing and a membrane stack inserted into it, which has several membranes that follow one another in a stacking direction. The membrane stack also has several longitudinal faces through which air can flow, as well as two opposing end faces through which air cannot flow. The humidifier is also equipped with two so-called sealing frames, which are arranged on two opposite longitudinal faces of the membrane stack and are tightly connected to two first air-ducting air nozzles of the housing in a flow-optimized manner, so that dry cathode incoming air can flow through the membrane stack along a first flow path. The housing also has two second air ducts, which are assigned to two further longitudinal faces of the membrane stack that are located opposite each other, so that humid cathode outgoing air can be guided along a second flow path through the membrane stack. The membranes alternately delimit incoming air ducts through which cathode incoming air flows and outgoing air ducts through which cathode outgoing air flows. The membranes are designed to be airtight and permeable to water vapor, allowing incoming and outgoing air to flow through the membrane stack without mixing, and enabling water to be transferred through the membranes from the outgoing air to the incoming air. This makes it possible to adjust the water content of the dry cathode incoming air relatively reliably.

The disadvantage of this well-known humidifier is that, when the humidifier is in operation, both the cathode incoming air and the cathode outgoing air are conducted through the incoming air ducts and the outgoing air ducts of the membrane stack at a higher pressure than, for example, the atmosphere surrounding the humidifier. As a result, the membrane stack is subject to continuous compressive stress, which manifests itself in particular as longitudinal expansion of the membrane stack, for example as a result of the inflation of the incoming air and outgoing air ducts. In this method, the longitudinal stretching of the membrane stack in the stacking direction is essentially only delimited by the mechanical cohesion of the membranes among themselves, so that progressive delamination in the region of the membranes of the membrane stack is possible, especially after a certain period of operation. This can lead to leaks between the ducts, which can cause an uncontrollable mixing of cathode outgoing air and cathode incoming air, for example, as well as a loss of performance, which is undesirable.

### SUMMARY

The purpose of the invention is therefore to provide an improved or at least a different design for a humidifier. In particular, a method for manufacturing such a humidifier is to be specified, as well as, in particular, a fuel cell system comprising such a humidifier

In the present invention, this task is solved in particular by the subject matter of the independent claim(s). Advantageous embodiments are the subject matter of the dependent claim(s) and the description.

The invention has recognized that the compressive stress occurring in the operation of the humidifier at the membrane stack and the resulting longitudinal expansion of the membrane stack in the stacking direction can be prevented or at least significantly reduced with the aid of supporting elements, which mechanically absorb the compressive forces acting on the membrane stack during the operation of the humidifier. The risk of delamination and leaks can therefore be eliminated or at least significantly reduced.

Accordingly, a humidifier is proposed for a fuel cell system for humidifying dry cathode incoming air by means of humid cathode outgoing air, which has a housing and a membrane stack consisting of several membranes that follow one another in a stacking direction. The membrane stack has two first longitudinal faces that are opposite each other and through which flow can occur, two second longitudinal faces that are opposite each other and through which flow can occur, and two end faces that are opposite each other and through which flow cannot occur. The first longitudinal faces and the second longitudinal faces are parallel to the stacking direction and the end faces are perpendicular to the stacking direction. It is essential that the humidifier has two end plates, which are each arranged on one end face, in particular in contact with each other. Furthermore, it is essential that the humidifier has supporting elements designed to absorb forces acting essentially along the stacking direction, in particular compressive forces, which are arranged in pairs opposite each other on the first and/or second longitudinal faces and are also attached, in particular exclusively, to the two end plates. In this case, the supporting elements and/or end plates are preferably made of a thermoplastic material such as polyamide (PA), polypropylene (PP) or polyethylene (PE).

The supporting elements together with the end plates form a belt-like stack binding that encloses the membrane stack, so to speak, and absorbs the pressure forces that occur in the membrane stack, particularly those acting in the stacking direction, when the humidifier is in operation. This subjects the supporting elements to tensile loading. This can reduce the compressive stress on the membrane stack during operation of the humidifier and, in particular, longitudinal expansion of the membrane stack in the stacking direction, and achieve mechanical stabilization of the membrane stack. This has the advantage of preventing damage to the membrane stack, in particular the aforementioned delamination of the membranes and/or the separation of the membrane stack from the end plates. The proposed humidifier is therefore relatively robust and has an improved product lifespan.

In particular, it may be provided that the membranes of the membrane stack are braced against each other in the stacking direction by means of the supporting elements. As a result, the membrane stack is compressed and prestressed to a certain extent in the stacking direction, which counteracts the compressive forces that arise when the humidifier is in operation. However, it is not absolutely necessary to tension the membranes of the membrane stack using the supporting elements if the components of the humidifier have been sufficiently geometrically designed, for example, if narrow tolerances have been selected.

It may be expedient to provide that the supporting elements are clamped or clipped to the end plates either detachably or non-detachably. This allows, in particular, for quick and easy installation of the supporting elements by clamping or clipping them onto the end plates, which can be done manually or automatically, for example. The clamp connection formed in each case is designed to be either releasable or non-releasable, so that, if necessary, the supporting elements can be released from the end plates or non-destructive deinstallation of the supporting elements can be prevented.

Furthermore, it may be provided that the supporting elements are clamped to the end plates in a releasable or non-releasable manner by means of clamping or clip connections, wherein the clamping or clip connections are each realized as a connection, in particular exclusively, based on a form fit or a form and force fit, between a respective supporting plate and the end plates. In other words, the supporting elements are each attached to the end plates by two or more clamping or clip connections. In particular, this means that mounting screws or the like are not required, so that manufacturing of the proposed humidifier is cost-effective overall.

It may be expedient to provide that the supporting elements are each formed by a plate running parallel to the stacking direction or have such a plate. The plates each have clamping edge regions opposite each other in the stacking direction, which are designed so that a respective supporting element can be clamped releasably or non-releasably to the two end plates by means of its clamping edge regions. This allows the supporting elements to be clamped or locked to the assembly of membrane stacks and end plates, wherein the clamping function is provided by the clamping edge regions of a plate of a supporting element.

The clamping regions of a plate are designed as an integral part of the plate for practical reasons. In other words, the plate and the clamping regions form a single-piece component. This can be achieved, for example, by manufacturing the supporting elements or plates with clamping regions in the frame of an injection molding or casting method, so that each component is cast in one piece. This means that the plates can be provided relatively inexpensively and in large quantities.

Furthermore, it can be expedient to provide that the clamping edge regions of a plate extend at least in sections and transversely to the stacking direction over the end plates. In this case, it is useful if the end plates each have an outer surface pointing away from the membrane stack, wherein the clamping edge regions of a plate each extend at least in sections and transversely to the stacking direction over the outer surfaces of the end plates and are supported at least in sections on the outer surface. This means that the supporting elements are used to grasp the assembly of membrane stacks and end plates. This locks the mobility of the end plates and the membrane stack in the stacking direction in a form-fit and/or force-fit manner.

It may be expedient to provide that the end plates each have an outer surface pointing away from the membrane stack. Furthermore, it is envisaged that the clamping edge regions each have at least one projection or are formed by at least one or more projections, wherein the projections of a plate each extend across the outer surfaces of the end plates at right angles to the stacking direction. The projections of a plate are each supported on the outer surfaces of the end plates and/or each interact with a complementarily designed counter-projection or a complementarily designed trough of a respective end plate to realize a clamping or clip connection. It is conceivable that the projections each form a hook or the like and engage and lock onto the outer surfaces of the end plates. As a result, the plates of the support elements are arranged in such a way that a support element can be detachably or non-detachably clamped to the two end plates by means of its clamping edge regions.

Furthermore, it may be expedient to provide that the supporting elements are each formed by a plate running parallel to the stacking direction or have such a plate, wherein the plates of the supporting elements are each penetrated by a through-flow opening, in particular a central opening, that is transverse to the stacking direction. When the humidifier is in operation, dry cathode incoming air flows through the openings in the plates, so that the openings in the supporting elements form air ducts, so to speak.

Furthermore, it may be expedient to provide that the plates each have an outer plate surface pointing away from the membrane stack, on which a sealing arrangement is provided that completely encircles the opening of a respective plate. The sealing arrangements are each formed by a sealing groove designed to accommodate a sealing agent and a sealing agent inserted into the sealing groove to seal the opening of a respective plate with respect to the housing of the humidifier. The sealing groove can, for example, be delimited or formed between two parallel, adjacent ribs arranged on the outer plate surface and the sealing agent can be arranged on the ribs. The corresponding ribs can be manufactured cost-effectively and at the same time help to stiffen each plate. The sealing agent can be realized, for example, by a sealing ring, a sealing cord or another suitable seal.

It may also be provided that the plates each have an inner plate surface pointing towards the membrane stack. An inner sealing arrangement can be provided on each of these inner panel surfaces, which completely surrounds the opening of a respective panel and via which a respective panel can be tightly placed on a first longitudinal face and/or a second longitudinal face. This allows a first air flow, in particular cathode incoming air or cathode outgoing air, to flow along a first flow path through the opening of a plate to the membrane stack, then through the membrane stack and, downstream of the membrane stack, through the opening of a further plate, while a second air flow, in particular cathode outgoing air or cathode incoming air, can flow through the membrane stack along a second flow path that is hermetically sealed from the first flow path.

It may be expedient to design the end plates without flow. In other words, the end plates are designed to be airtight, which means that they are free of any openings or through-holes that completely penetrate the respective end plate. This can be used to reliably prevent unwanted leakage of cathode incoming air and/or cathode outgoing air through the front faces of the membrane stack.

Furthermore, it may be expedient to ensure that the end plates and/or the supporting elements, i.e. in particular their plates, are designed to be resistant This means that the end plates and/or the plates are resistant to mechanical stress and are rigid against bending. This stabilizes the membrane stack, so that it has no or only a small amount of inherent mobility.

It may be expedient to provide that the supporting elements are each formed by a plate running parallel to the stacking direction or have such a plate, the plates each have an outer plate surface pointing away from the membrane stack, wherein stiffening ribs for stiffening a respective plate are arranged on the outer plate surfaces of the plates. In this case, the stiffening ribs can preferably be aligned parallel to the stacking direction and then form longitudinal stiffening ribs. It is understood that the stiffening ribs may instead or additionally be oriented transversely to the stacking direction, in which case they form transverse stiffening ribs. The mechanical strength of a plate, in particular its flexural rigidity, can be increased by means of appropriate stiffening ribs. This allows for better mechanical stabilization of the membrane stack.

Furthermore, it may be expedient to provide that the end plates and/or the supporting elements, i.e. in particular their plates, are made of a metallic material, a plastic material or a composite material. This ensures both high flexural rigidity and cost-effective manufacturing of the end plates.

The proposed humidifier has exactly two supporting elements, which are arranged in pairs opposite each other on the first or second longitudinal faces and attached to the two end plates.

It is understood that the proposed humidifier may, for practical reasons, have two further supporting elements in addition to the two supporting elements mentioned, so that the humidifier as a whole has exactly four supporting elements. The four supporting elements are each attached to the two end plates and arranged in pairs opposite each other on the first and second longitudinal faces. This can further improve the mechanical stabilization of the membrane stack in particular, as well as the absorption of pressure forces acting in the stacking direction in the membrane stack during operation of the humidifier.

The supporting elements are purposefully designed as identical parts. The end plates can also be designed as non-variable parts.

According to another basic principle of the invention, a method for manufacturing a humidifier according to the above description is provided. The proposed manufacturing method involves the following successive steps:
a housing is provided,
a membrane stack is provided from several membranes that follow one after the other in a stacking direction,
two end plates are provided and arranged in particular in contact with each other on opposite, non-permeable end faces of the membrane stack,
the assembly formed from the membrane stack and end plates is compressed in the stacking direction,
supporting elements are provided and each attached to the two end plates, in particular clamped or clipped on.

This is an easy-to-install and cost-effective way to manufacture a humidifier. By compressing the assembly of membrane stacks and end plates and then clamping the supporting elements onto this assembly, the membranes are or remain braced against each other in the stacking direction. It is useful to insert the assembly of membrane stack, end plates and supporting elements into the humidifier housing in a subsequent step.

According to a further basic principle of the invention, a fuel cell system is provided, in particular a fuel cell system for motor vehicles or a stationary fuel cell system, which has at least one or more humidifiers for humidifying a dry cathode incoming air by means of a humid cathode outgoing air, which is or are formed according to the above description or manufactured according to the manufacturing method explained above. This indicates an advantageous fuel cell system with at least one relatively long-lasting humidifier. The proposed fuel cell system can thus be operated maintenance-free for a relatively long period of time, which is particularly desirable in the automotive sector.

To summarize, it remains to be said: The present invention relates in particular to a humidifier for humidifying dry cathode incoming air by means of humid cathode outgoing air, comprising a housing and a membrane stack made of several membranes arranged one after the other in a stacking direction. Essential to the invention is that the humidifier has two end plates, each of which is arranged on one end face of the membrane stack, and that the humidifier has supporting elements, each of which is arranged on longitudinal faces of the membrane stack through which air can flow and is attached to the two end plates. The invention relates in particular to a method for manufacturing a humidifier and, more particularly, to a fuel cell system with at least one humidifier.

Further important features and advantages of the invention are apparent from the sub-claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred embodiments of the invention are shown in the drawings and are explained in more detail in the following description, wherein identical reference signs refer to identical or similar or functionally identical components.

### BRIEF DESCRIPTION OF THE DRAWINGS

They show, schematically in each case

FIG. 1 shows a perspective view of a preferred embodiment of a humidifier according to the invention and

FIG. 2 shows a section of the humidifier in FIG. 1 in a plan view according to an arrow II drawn in FIG. 1.

### DETAILED DESCRIPTION

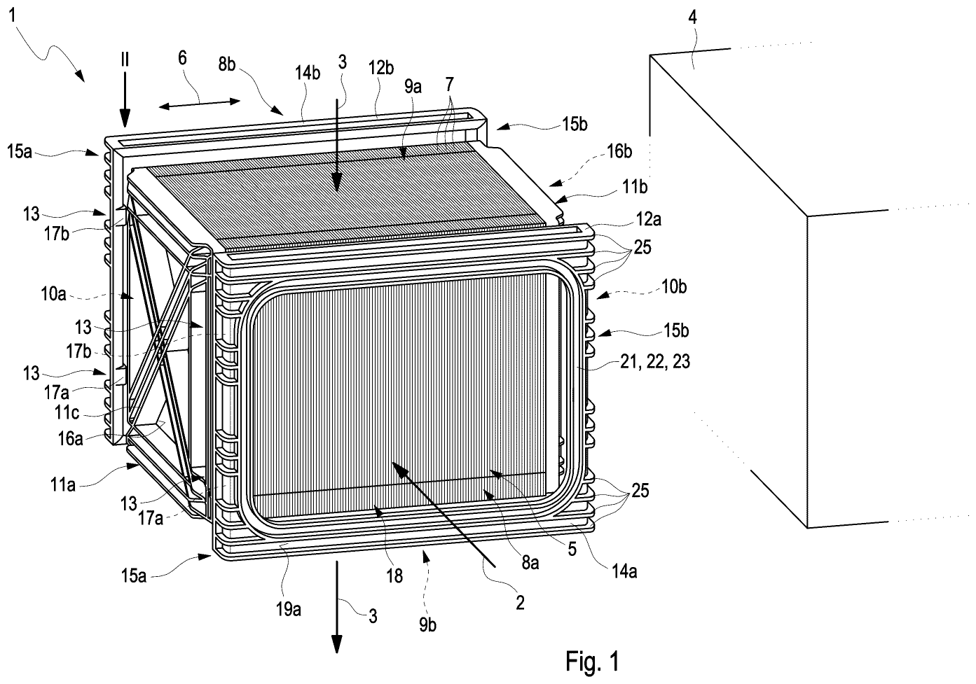

FIG. 1 shows a preferred embodiment of a humidifier, designated by the reference number 1, for an unillustrated fuel cell system. The humidifier 1 is designed to humidify a dry cathode incoming air 2, indicated by an arrow and forming an initial air stream, by means of a humid cathode outgoing air 3, also indicated by an arrow, of a second air stream.

For this purpose, humidifier 1 has a housing 4 that is only partially indicated, as well as a membrane stack 5 consisting of several membranes that follow one another in a stacking direction 6, of which only a few are uniformly labelled with the reference number 7 in FIG. 1 for the sake of clarity. The membrane stack 5 can be inserted completely into the housing 4 in the stacking direction 6 and has first, opposite longitudinal faces 8a, 8b, furthermore second, opposite longitudinal faces 9a, 9b as well as two, non-permeable, opposite end faces 10a, 10b. The first longitudinal faces 8a, 8b and the second longitudinal faces 9a, 9b are each aligned parallel to the stacking direction 6 and are orthogonal to each other. The end faces 10a, 10b are each aligned transversely to the stacking direction 6 and, together with the first longitudinal faces 8a, 8b and the second longitudinal faces 9a, 9b, form a cuboid body. The membranes 7 delimit between them incoming air ducts through which cathode incoming air 2 can flow, alternating with outgoing air ducts through which cathode outgoing air 3 can flow. The membranes 7 are designed to be airtight and permeable to water vapor, so that when the humidifier 1 is in operation, the first air flow from the cathode incoming air 2 flows through the membrane stack 5 along a first flow path and the second air flow from the cathode outgoing air 3 flows along a second flow path without mixing. However, since water vapor can pass through the membranes 7, water can be transferred from the cathode outgoing air 3 to the cathode incoming air 2.

FIG. 1 shows that the proposed humidifier 1 also has end plates 11a, 11b, which are arranged on the said end faces 10a, 10b of the membrane stack 5. The two end plates 11a, 11b are designed to be rigid and, for this purpose, have in the present case in particular stiffening ribs 11c, each of which extends upwards from an outer surface 16a, 16b of an end plate 11a, 11b pointing away from the membrane stack 5 and stiffening a respective end plate 11a, 11b.

FIG. 1 also shows that the proposed humidifier 1 has two separate, identically designed supporting elements 12a, 12b. The supporting elements 12a, 12b are arranged in pairs opposite each other on the first two longitudinal faces 8a, 8b, at right angles to the stacking direction 6, and are attached to the two end plates 11a, 11b. The supporting elements 12a, 12b are configured to absorb forces that act substantially in stacking direction 6 during operation of the humidifier 1 and in particular originate from a compressive stress of the membrane stack 5 and/or a change in length of the membrane stack 5. The supporting elements 12a, 12b are each formed by a frame-like, flat plate 14a, 14b running parallel to the stacking direction 6. The plates 14a, 14b of the supporting elements 12a, 12b each have clamping edge regions 15a opposite each other, 15b in the stacking direction 6, which are designed to produce a clamping or clip connection 13 between a respective plate 14a, 14b and the end plates 11a, 11b. The clamp or clip connection 13 is preferably designed to be either removable or non-removable and relies exclusively on a form fit or a form and force fit. This allows the supporting elements 12a, 12b to be easily clamped to the end plates 11a, 11b and released again if necessary.

A central, approximately rectangular opening 18 passes through each of the plates 14a, 14b of the supporting elements 12a, 12b. In this case, an opening 18 leads on the one hand to an outer plate surface 19a, 19b of a respective plate 14a, 14b, which points away from the membrane stack 5, and on the other hand to an inner plate surface 19c of a respective plate 14a, 14b, so that air can flow through the supporting elements 12a, 12b through a respective opening 18. The plates 14a, 14b each also have a sealing arrangement 21 that completely encircles the respective opening 18, by means of which the supporting elements 12a, 12b can be arranged in a sealed manner on the housing 4 of the humidifier 1. The seal arrangements 21 each have a continuous sealing groove 22 for accommodating a sealing agent 23 which serves to seal the respective opening 18 with respect to the housing 4. The supporting elements 12a, 12b also have a plurality of stiffening ribs 25 on their plates 14a, 14b, which are provided to stiffen a respective plate 14a, 14b. The stiffening ribs 25 extend transversely to the stacking direction 6 over the outer panel surface 19a, 19b of a respective panel 14a, 14b and extend in their respective main direction of extension along the stacking direction 6, so that they form longitudinal stiffening ribs. It is understood that in a further embodiment of the invention, not illustrated here, the supporting elements 12a, 12b can be designed without stiffening ribs or with longitudinal stiffening ribs and/or transverse stiffening ribs running transversely to the longitudinal stiffening ribs, without departing from the scope of the invention.

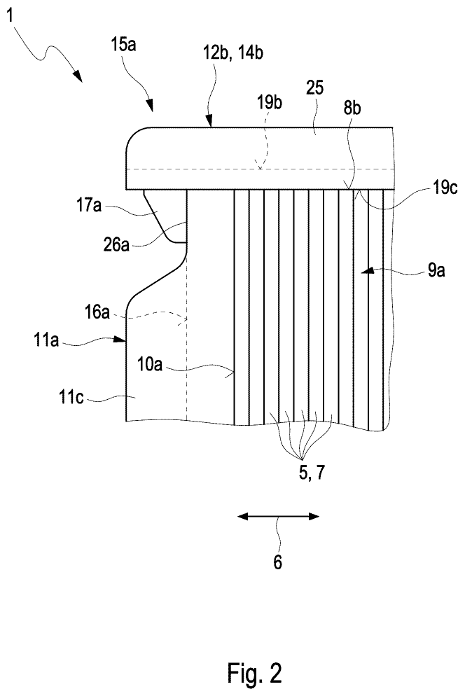

FIG. 2 shows that the clamping edge regions 15a, 15b of a plate 14a, 14b each have at least one projection 17a, 17b or are formed by one. The projections 17a, 17b protrude transversely to the stacking direction 6 over the outer surfaces 16a, 16b of the end plates 11a, 11b and are each clamped to the outer surfaces 16a, 16b and expediently cooperate with a counter-projection 26a of a respective end plate 11a, 11b to form a clamp—or clip connection 13 to form.

1. A humidifier for humidifying dry cathode incoming air via humid cathode outgoing air for a fuel cell system, comprising:
a housing;
a membrane stack including a plurality of membranes arranged one after another in a stacking direction, the membrane stack having:
two first longitudinal faces arranged opposite one another and through which a fluid is flowable;
two second longitudinal faces arranged opposite one another and through which a fluid is flowable; and
two opposing end faces through which a fluid is not flowable;
the two first longitudinal faces and the two second longitudinal faces aligned parallel to the stacking direction and the two end faces aligned transversely to the stacking direction;
two end plates each arranged on a respective end face of the two end faces; and
a plurality of supporting elements configured to absorb forces acting essentially along the stacking direction, the plurality of supporting elements arranged in pairs opposite each other at least one of on the two first longitudinal faces and on the two second longitudinal faces, and attached to the two end plates.

2. The humidifier according to claim 1, wherein the plurality of membranes are clamped to one another in the stacking direction the plurality of supporting elements.

3. The humidifier according to claim 1, wherein the plurality of supporting elements are each clamped to the two end plates releasably.

4. The humidifier according to claim 1, wherein:
the plurality of supporting elements are clamped to the two end plates at least one of detachably and non-detachably via at least one of a plurality of clamping connections and a plurality of clip connections; and
the at least one of the plurality of clamping connections and the plurality of clip connections are each based on at least one of a form fit and a form and force fit between a respective supporting element of the plurality of supporting elements and the two end plates.

5. The humidifier according to claim 1, wherein:
the plurality of supporting elements are structured as a plurality of plates extending parallel to the stacking direction;
the plurality of plates each have a plurality of clamping edge regions disposed opposite one another in the stacking direction; and
the plurality of clamping edge regions of each of the plurality of plates are configured such that a respective supporting element of the plurality of supporting elements is at least one of releasably and non-releasably clamped to the two end plates via the plurality of clamping edge regions of the respective supporting element.

6. The humidifier according to claim 5, wherein the plurality of clamping edge regions of at least one supporting element of the plurality of supporting elements each extend, at least in sections, transversely to the stacking direction over the two end plates.

7. The humidifier according to claim 5, wherein:
the two end plates each have an outer surface facing away from the membrane stack;
the plurality of clamping edge regions each include at least one projection such that each of the plurality of supporting elements includes a plurality of projections;
the plurality of projections of at least one supporting element of the plurality of supporting elements each extend transversely to the stacking direction beyond the outer surfaces of each of the two end plates; and
the plurality of projections of at least one supporting element of the plurality of supporting elements are each supported on the outer surfaces of an associated end plate of the two end plates.

8. The humidifier according to claim 1, wherein:
the plurality of supporting elements are structured as a plurality of plates extending parallel to the stacking direction; and
each plate of the plurality of plates includes an opening through which a fluid is flowable transversely to the stacking direction.

9. The humidifier according to claim 8, wherein:
each plate of the plurality of plates has an outer plate surface facing away from the membrane stack and through which the opening opens;
each plate of the plurality of plates includes a sealing arrangement that completely encircles the opening; and
the seal arrangements of each of the plurality of plates includes:
a sealing agent; and
a seal groove configured to accommodate the sealing agent, the sealing agent arranged in the seal groove and sealing the opening with respect to the housing.

10. The humidifier according to claim 9, wherein each of the plurality of plates include a plurality of stiffening ribs configured to stiffen the respective plate.

11. The humidifier according to claim 1, wherein the two end plates are rigid.

12. A method for manufacturing the humidifier according to claim 1, comprising:
providing the housing;
providing the membrane stack from the plurality of membranes arranged one after another in the stacking direction;
arranging the two end plates on the two opposite, non-permeable end faces of the membrane stack to form an assembly;
compressing the assembly formed from the membrane stack and the two end plates in the stacking direction; and
attaching two supporting elements of the plurality of supporting elements to the two end plates respectively.

13. A fuel cell system, comprising at least one humidifier according to claim 1.

14. The method according to claim 12, wherein attaching the two supporting elements to the two end plates includes clamping the two supporting elements to the two end plates.

15. The method according to claim 12, wherein attaching the two supporting elements to the two end plates includes clipping the two supporting elements to the two end plates.

16. The humidifier according to claim 1, wherein the plurality of supporting elements are each non-releasably clamped to the two end plates.

17. The humidifier according to claim 7, wherein the plurality of projections of the at least one supporting element each cooperate with a complementarily shaped counter-projection of a respective end plate of the two end plates to provide at least one of a clamping connection and a clip connection.

18. The humidifier according to claim 1, wherein the two end plates are composed of at least one of a metallic material, a plastic material, or a composite material.

19. The humidifier according to claim 1, wherein the plurality of supporting elements are rigid.

20. The humidifier according to claim 1, wherein the plurality of supporting elements are composed of at least one of a metallic material, a plastic material, or a composite material.
